(19) United States
(12) Patent Application Publication
(10) Pub. No.: US 2009/0036099 A1
(43) Pub. Date: Feb. 5, 2009

(54) Content providing method and system

(75) Inventor: Kyu Hui Han, Gumi-Si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/220,273

(22) Filed: Jul. 23, 2008

(30) Foreign Application Priority Data
Jul. 25, 2007 (KR) 2007-0074457

(51) Int. Cl. H04M 1/66

(52) U.S. Cl. 455/411

(57) ABSTRACT

A content providing method and system are disclosed that enable content producers to make a profit by providing contents encrypted by a mobile terminal. The content providing method includes: encrypting, by a mobile terminal, a content and registering the encrypted content in a content providing server; finding, by a communication terminal, the content registered in the content providing server and paying a use fee to use the content; and transmitting a valid authentication key associated with the content to the communication terminal after the payment. Accordingly, since content producers directly encrypt their contents, they can make a profit corresponding to the use of the contents.

### CROSS-REFERENCE TO RELATED APPLICATION(S) AND CLAIM OF PRIORITY

This application claims priority to an application entitled “CONTENT PROVIDING METHOD AND SYSTEM” filed in the Korean Intellectual Property Office on Jul. 25, 2007 and assigned Serial No. 2007-0074457, the contents of which are incorporated herein by reference.

### TECHNICAL FIELD OF THE INVENTION

The present invention relates generally to digital contents and, more particularly, to a content providing method and system that enable content providers to make a profit.

### BACKGROUND OF THE INVENTION

In recent years, with advances in personal digital information devices such as digital cameras, the average person can create digital contents using a simple authoring tool. Contents created by users known as User Created Contents (UCC) or User Generated Contents (UGC) have been rapidly popularized through instant release and feedback using open networks such as the Internet.

In most cases, UCC creators register their contents with general portal sites or UCC specific sites. Most UCC creators just desire their UCC to be available to other persons through registration and do not make a profit from their UCC. As a result, it is expected that currently created and provided UCC tend to have poor quality, and the motivation for UCC creation may be weakened.

Hence, it is necessary to provide a system that enables UCC creators or providers to make a profit through the creation and provision of UCC.

### SUMMARY OF THE INVENTION

To address the above-discussed deficiencies of the prior art, it is a primary object of the present invention to provide a content providing method and system that enable a content producer to make a profit by providing encrypted contents through a mobile terminal.

In accordance with an aspect of the present invention, the present invention provides a content providing method including: encrypting, by a mobile terminal, a content and registering the encrypted content with a content providing server; finding, by a communication terminal, the content registered in the content providing server and paying a use fee to use the content; and transmitting a valid authentication key associated with the content to the communication terminal after the payment.

In accordance with another aspect of the present invention, there is provided a content providing system including: a mobile terminal encrypting and providing a content; a communication terminal acquiring and using the encrypted content; and a content providing server providing the encrypted content from the mobile terminal to the communication terminal, and collecting a use fee for the content from the communication terminal.

In a feature of the present invention, contents are directly encrypted by a mobile terminal and registered in a content providing server. When other users carrying their terminals desire to use the encrypted contents, they can acquire a valid authentication key after payment of a use fee for the contents.

As a result, the user of a mobile terminal can directly exercise rights to the contents, and make a profit by providing encrypted contents.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic block diagram illustrating a content providing system according to an exemplary embodiment of the present invention;

FIG. 2 is a block diagram illustrating a mobile terminal in accordance with the principles of the present invention;

FIG. 3 is a sequence diagram illustrating a content providing method according to another exemplary embodiment of the present invention;

FIG. 4 is a flow chart illustrating a content encryption procedure in the method of FIG. 3 performed by a mobile terminal;

FIG. 5 is a flow chart illustrating a content registration procedure in the method of FIG. 3 performed by the mobile terminal; and

FIG. 6 is a flow chart illustrating a valid authentication key providing procedure in the method of FIG. 3 performed by the mobile terminal.

### DETAILED DESCRIPTION OF THE INVENTION

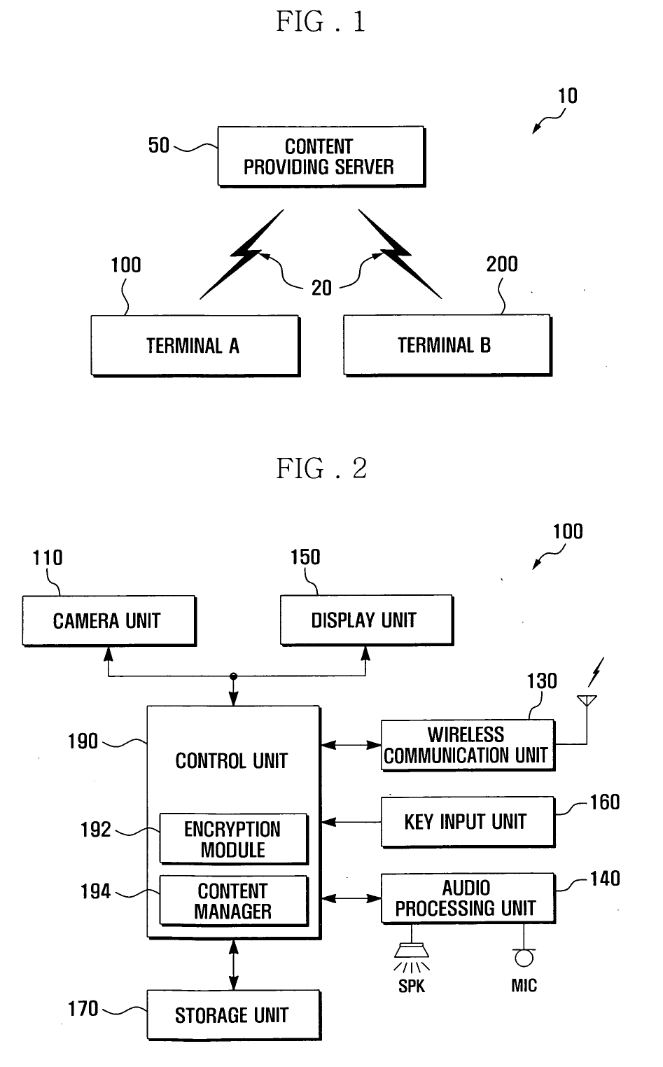

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

In the description, the term “contents” (or content data) denotes digital contents that are electronic data, information, knowledge, or database expressed in symbols, characters, voices, sounds, images and videos, and processed through information technology. In particular, contents mean UCC or UGC.

An exemplary embodiment of the present invention is described in detail.

FIG. 1 is a schematic block diagram illustrating a content providing system 10 according to an exemplary embodiment of the present invention.

Referring to FIG. 1, the content providing system 10 includes a mobile terminal (hereinafter referred to as ‘terminal A’) 100, another terminal (hereinafter referred to as ‘terminal B’) 200, and a content providing server 50, which is accessed by the terminal A 100 and the terminal B 200 through a network 20. The network 20 may be any type of communication network permitting the terminal A 100 and the terminal B 200 to access the Internet.

When the terminal A 100 or the terminal B 200 requests desired contents (for example, UCC) through the network 20, the content providing server 50 provides the requested contents to the terminal A 100 or the terminal B 200 in a streaming or download format. The provided contents may be Digital Rights Management (DRM)-encrypted contents that are encrypted by the content providing server 50 using a DRM technique or by the content producer using the terminal A 100.

The terminal A 100 and the terminal B 200 may be any type of terminal that can access the content providing server 50 through the network 20. In particular, the terminal B 200 according to this embodiment collectively indicates terminals other than the terminal A 100.

The terminal A 100 can register content with or download desired contents from the content providing server 50. For registration, the terminal A 100 encrypts contents and registers the encrypted contents with the content providing server 50. Next, the terminal A 100 is described in detail.

FIG. 2 is a block diagram illustrating the mobile terminal A 100.

The mobile terminal A 100 includes a camera unit 110, a wireless communication unit 130, an audio processing unit 140, a key input unit 160, a display unit 150, a storage unit 170, and a control unit 190.

The camera unit 110 provides a preview image for capturing an image. Upon receipt of a request from the user, the camera unit 110 is driven to capture an input image. To achieve this, the camera unit 110 includes a lens (not shown) forming an image, a camera sensor (not shown) converting an optical signal corresponding to the formed image into an electric signal, and a signal processor (not shown) converting the analog electric signal into digital data. A charge coupled device (CCD) sensor may be used as the camera sensor, and a digital signal processor (DSP) may be used as the signal processor. However, the present invention is not limited thereto.

Although not shown, the camera unit 110 includes an image processor. The image processor processes an image signal from the camera unit 110 in units of frames and outputs frame image data corresponding to the display characteristics and the size of the display unit 150. Further, the image processor compresses the image data and transmits the compressed image data to the control unit 190. The image processor includes an image coder/decoder (CODEC), which compresses image data to be displayed on the display unit 150 in a preset format and restores compressed image data to the original image data. Various CODECs such as JPEG, Wavelet, MPEG2, MPEG4, H.263, and H.264 CODEC may be used as the image CODEC. The camera unit 110 is readily used to capture moving or still images required for creating content such as UCC.

The wireless communication unit 130 performs data transmission and reception operations through wireless communication for the mobile terminal A 100. The wireless communication unit 130 may include an RF transmitter upconverting the frequency of a signal to be transmitted and amplifying the signal, and an RF receiver low-noise amplifying a received signal and downconverting the frequency of the signal. The wireless communication unit 130 can receive data through a wireless channel, output the received data to the control unit 190, and transmit data from the control unit 190 through the wireless channel.

The audio processing unit 140 includes a CODEC. The CODEC can include a data CODEC to process packet data, and an audio CODEC to process audio signals such as voices. During a call, the audio processing unit 140 converts digital audio data from the control unit 190 into an analog audio signal through the audio CODEC and outputs the analog audio signal to a speaker. The audio processing unit 140 also converts an analog audio signal from a microphone into digital audio data through the audio CODEC and provides the digital audio data to the control unit 190.

The display unit 150 displays a menu of the mobile terminal A 100, data input by the user, function setting information, and various information to be provided to the user. The display unit 150 may include a panel of liquid crystal display (LCD) devices, an LCD controller for controlling the LCD devices, and a video memory for storing video data. If the panel has a touch screen capability, the display unit 150 can act as an input device.

The key input unit 160 receives a user operation signal for controlling the mobile terminal A 100, and transfers the received user operation signal to the control unit 190. The key input unit 190 includes a control key (not shown) for operation control and a plurality of numeric keys (not shown) for inputting characters and numbers.

The storage unit 170 stores application programs necessary for operations according to the present embodiment, downloaded contents, and user data generated by the user. The storage unit 170 can include a data section and a program section.

The program section stores an operating system (OS) for booting the mobile terminal A 100, and application programs for other optional functions of the mobile terminal A 100 such as a music playback function and still image or moving image playback function. When one of these functions is activated in response to a user request, the mobile terminal A 100 executes a corresponding application program under the control of the control unit 190. In addition, the storage unit 170 may include at least one buffer to temporarily store user data, such as songs, still images and moving images, generated from execution of application programs related to playback of music files and moving images.

The data section is an area storing user data generated from the use of the mobile terminal A 100 and can store digital content data such as music files and moving image files.

Further, contents such as UCC or UGC produced or edited by the user are stored in the data section of the storage unit 170 in this embodiment. When contents are encrypted according to the user request, a sample key and a valid authentication key associated with the contents are stored together in the storage unit 170.

The control unit 190 controls the overall operation of the mobile terminal A 100 and the signal exchange between internal blocks thereof. The control unit 190 controls signal exchange between the internal blocks including the camera unit 110, the wireless communication unit 130, the audio processing unit 140, the display unit 150, the key input unit 160, and the storage unit 170.

The control unit 190 executes a requested function of the mobile terminal A 100 according to an input signal from the key input unit 160, and controls the display unit 150 to display the current state of the function in execution and information to be provided to the user such as a menu.

In particular, the control unit 190 encrypts contents selected by the user and manages the encrypted contents. To achieve this, the control unit 190 includes an encryption module 192 and a content manager 194.

The encryption module 192 encrypts a content selected by the user. During encryption of the content, the encryption module 192 generates and stores a valid authentication key and a sample key associated with the content. In this embodiment, a DRM technique is used to encrypt the digital contents. DRM relates to protection and management of copyrighted digital contents. Using cryptography, DRM aims to achieve secure delivery of various contents from content providers to users, and to prevent unauthorized redistribution of contents delivered to users. The DRM technique is widely known, and a detailed description thereof is omitted. Although, in this embodiment, the encryption module 192 uses the DRM technique, the present invention is not limited to the DRM technique. Other techniques capable of encrypting digital contents may also be used.

The content manager 194 registers a content encrypted by the encryption module 192 and an associated sample key with the content providing server 50. When a message requesting a valid authentication key is received from the content providing server 50, the content manager 194 transmits the corresponding valid authentication key to the content providing server 50.

A content providing method according to an exemplary embodiment of the present invention will now be described in detail. The construction of the content providing system 10 will be more apparent from the following description of the content providing method.

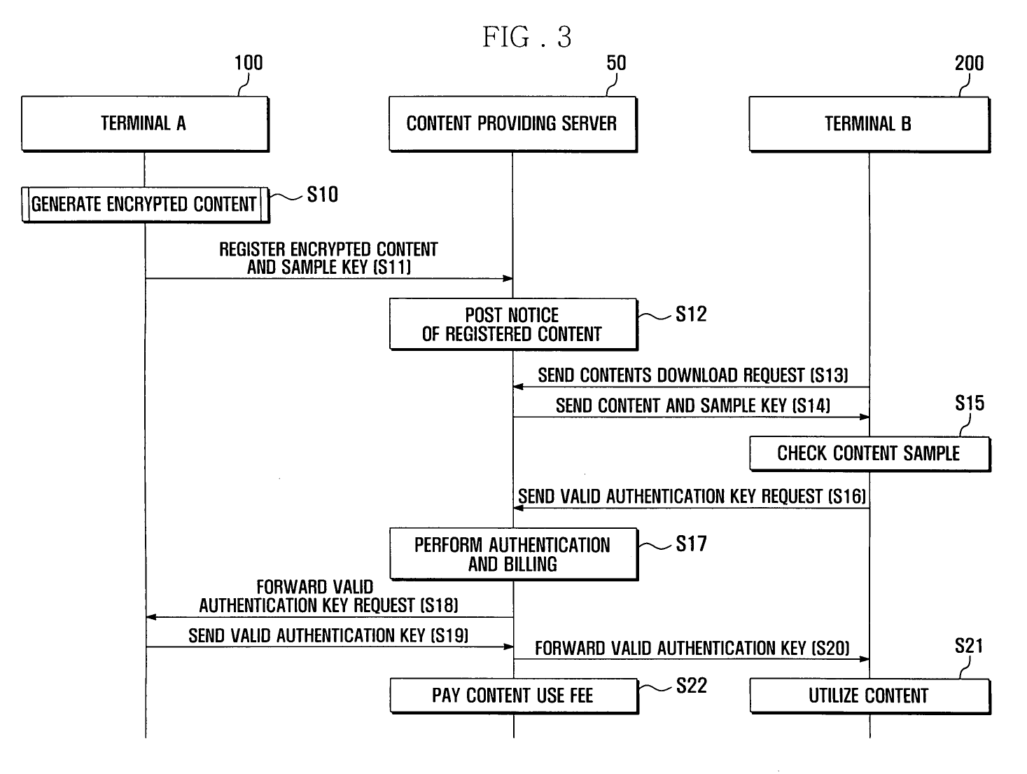

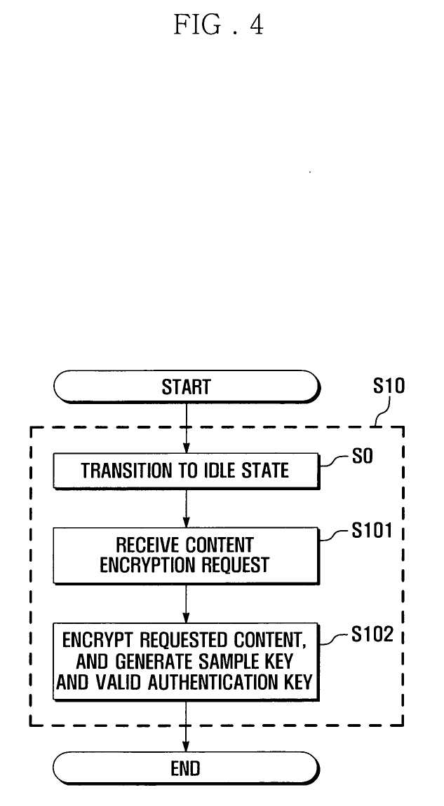

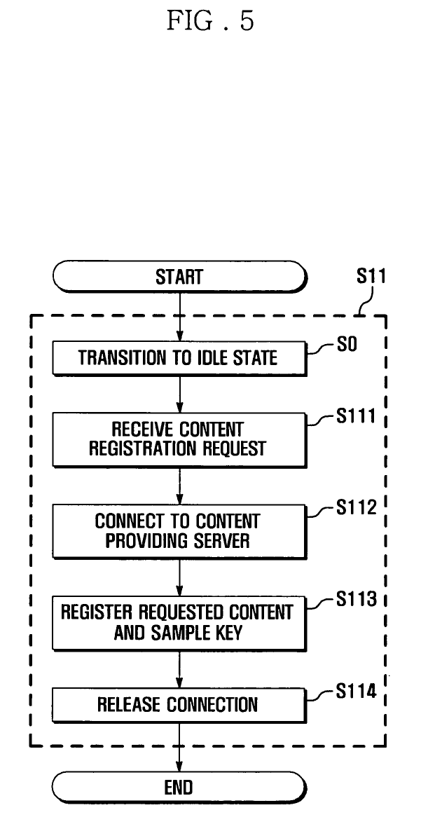

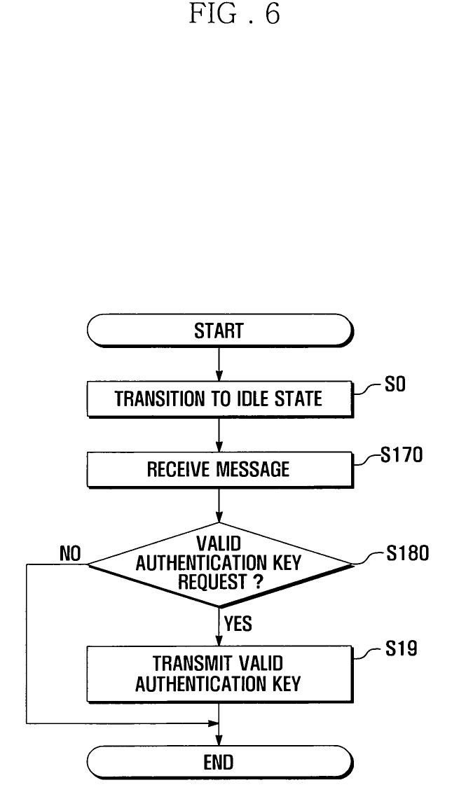

FIG. 3 is a sequence diagram illustrating a content providing method according to another exemplary embodiment of the present invention. FIG. 4 is a flow chart illustrating a procedure performed by a mobile terminal to encrypt a content in the content providing method. FIG. 5 is a flow chart illustrating a procedure performed by the mobile terminal to register a content with the content providing method. FIG. 6 is a flow chart illustrating a procedure performed by the mobile terminal to provide a valid authentication key in the content providing method.

Referring to FIGS. 1 to 6, the content providing method performed by the content providing system 10 is described.

Referring to FIG. 3, the terminal A 100 encrypts a selected content (S10).

Referring to FIG. 4, when power is applied, the terminal A 100 starts a normal operation and transitions to an idle state (S0).

During the idle state, the terminal A 100 receives a content encryption request from the user (S101). When the user selects a content to be encrypted and issues an encryption request through the key input unit 160, the encryption module 192 of the control unit 190 encrypts the selected content to generate an encrypted content (‘DRM-encrypted content’) (S102). In step S102, the encryption module 192 generates a valid authentication key permitting use of the DRM-encrypted content and a sample key permitting use of a part of the DRM-encrypted content in addition to the encrypted content.

After encryption, a procedure is performed to register the DRM-encrypted content with the content providing server 50 according to a user request (S11).

Referring to FIG. 5, while the terminal A 100 is in the idle state (S0), the user issues a content registration request using the key input unit 160 to register the DRM-encrypted content with the content providing server 50 (S111). The content manager 194 of the control unit 190 connects to the content providing server 50 for content registration (S112).

To access the content providing server 50, the content manager 194 connects to the content providing server 50 through the network 20. In this embodiment, the terminal A 100 accesses the content providing server 50 in response to a content registration request. However, the user may input a content registration request after the terminal A 100 connects to the content providing server 50.

After a connection between the terminal A 100 and the content providing server 50 is established, the content manager 194 of the terminal A 100 registers the DRM-encrypted content selected by the user with the content providing server 50 (S113). The content manager 194 transmits the DRM-encrypted content generated at step S10 and the associated sample key to the content providing server 50. At this time, the associated valid authentication key is not transmitted to the content providing server 50.

When the DRM-encrypted content and the sample key are transmitted together to the content providing server 50, the content manager 194 releases the connection to the content providing server 50 (S114). If the user continues to use the content providing server 50, step 114 can be omitted.

After the DRM-encrypted content and the associated sample key from the terminal A 100 are registered, the content providing server 50 posts a notice of registration of the DRM-encrypted content (S12). This notice of the registration permits all other terminals capable of accessing the content providing server 50 to select and download the registered DRM-encrypted content for use.

In this embodiment, the terminal B 200 accesses the content providing server 50 and sends a download request for the DRM-encrypted content to the content providing server 50 (S13).

In response to this request, the content providing server 50 transmits the requested DRM-encrypted content and associated sample key to the terminal B 200 (S14).

After the requested DRM-encrypted content and associated sample key are transmitted together to the terminal B 200, the user of the terminal B 200 can use the acquired DRM-encrypted content. In this case, because the user of the terminal B 200 accesses the DRM-encrypted content using the sample key, the user can view only a part of the DRM-encrypted content.

When the user of the terminal B 200 desires to view the entire DRM-encrypted content after viewing a part of the DRM-encrypted content, the user sends a request for the valid authentication key to the content providing server 50 (S16).

When the content providing server 50 receives the request for the valid authentication key from the terminal B 200, it executes an authentication and billing procedure for the terminal B 200 (S17). The authentication and billing procedure is a process to pay a use fee for DRM-encrypted contents. The content providing server 50 authenticates the user of the terminal B 200 and charges the content use fee to the authenticated user. Authentication and billing through a network is known in the art, and a detailed description thereof is omitted.

After the user of the terminal B 200 pays the use fee for the DRM-encrypted content through the authentication and billing procedure, the content providing server 50 sends a request for the valid authentication key to the terminal A 100 (S18). In this embodiment, the content providing server 50 sends a request for a valid authentication key to the terminal A 100 using a short message service (SMS) or multimedia message service (MMS) message. However, the present invention is not limited thereto, and other means such as a push message or an e-mail may also be used if they enable transmission of a valid authentication key request to the terminal A 100.

Upon receipt of the request for the valid authentication key from the content providing server 50, the terminal A 100 performs a procedure to transmit the valid authentication key (S19).

Referring to FIG. 6, when a message such as SMS message is received by the terminal A 100 in the idle state (S170), the control unit 190 checks whether the received message is a message requesting a valid authentication key (S180).

If the received message is an ordinary message not requesting a valid authentication key, the control unit 190 displays the received message to the user as usual.

If the received message is a message requesting a valid authentication key, the content manager 194 transmits the requested valid authentication key stored in the storage unit 170 to the content providing server 50 (S19). In step S19, the content manager 194 may attach the valid authentication key to an MMS message and transmit the MMS message to the content providing server 50, or may directly access the content providing server 50 to transmit the valid authentication key.

Thereafter, upon receipt of the valid authentication key, the content providing server 50 forwards the valid authentication key received from the terminal A 100 to the terminal B 200 (S20).

As a result, the terminal B 200 can acquire the valid authentication key and access the entire DRM-encrypted content with the acquired valid authentication key (S21).

After transmission of the valid authentication key to the terminal B 200, the content providing server 50 pays a corresponding use fee to the user of the terminal A 100 for the provided DRM-encrypted content (S22). Such payment may be performed through various manners (e.g., by directly depositing the use fee in a bank account of the user of the terminal A 100 or by reducing the call charge for the terminal A 100).

As apparent from the above description, in a method and system for providing contents according to the present invention, a mobile terminal directly encrypts contents and registers the encrypted contents with a content providing server. Consequently, content producers can directly exercise rights to their contents, and make a profit corresponding to the use of the contents.

Although exemplary embodiments of the present invention have been described in detail hereinabove, it should be understood that many variations and modifications of the basic inventive concept herein described will still fall within the spirit and scope of the exemplary embodiments of the present invention as defined in the appended claims. For example, in the description, the user of a terminal B downloads a DRM-encrypted content and the associated sample key and accesses a part of the DRM-encrypted content using the sample key. However, the present invention is not limited thereto, and a part of the DRM-encrypted content may also be provided as a sample in a streaming format.

In addition, in the description, upon receipt of a request for a valid authentication key from the terminal B, the content providing server forwards the request to the terminal A. However, the content providing server may provide a previously acquired valid authentication key. In this case, during content registration, an encrypted content, an associated sample key and valid authentication key are registered together with the content providing server. Then, upon receipt of a request for the valid authentication key from the terminal B, the content providing server performs authentication and billing and provides the valid authentication key to the terminal B. Thereafter, the content providing server preferably transmits a message notifying performance of authentication and billing to the terminal A.

Further, in the description, mobile terminals are utilized to provide and use contents. However, other electronic devices capable of generating and encrypting contents may also be used in the embodiments.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A content providing method comprising:
encrypting, by a mobile terminal, a content and registering the encrypted content with a content providing server;
receiving, by the mobile terminal, a request for a valid authentication key associated with the encrypted content from the content providing server after the content providing server receives a user fee from a user; and
transmitting, by the mobile terminal, the valid authentication key to the content providing server.

2. The method of claim 1, wherein the content is a User Created Content (UCC) or a User Generated Content (UGC).

3. The method of claim 2, wherein encrypting a content and registering the encrypted content comprises encrypting the content and generating the valid authentication key and a sample key.

4. The method of claim 3, wherein the sample key is an authentication key permitting decryption of only a part of the content.

5. The method of claim 3, wherein encrypting a content and registering the encrypted content comprises registering the sample key with the content providing server together with the encrypted content.

6. The method of claim 1, wherein the request for a valid authentication key is received by the mobile terminal by way of an SMS or MMS message.

7. The method of claim 1, wherein the user of the mobile terminal receives a payment from the content providing server.

8. A content providing method comprising:
receiving an encrypted content from a mobile terminal;
receiving a user fee from a user of a communication terminal requesting access to the encrypted content;
transmitting a request for a valid authentication key to the mobile terminal;
receiving a valid authentication key associated with the encrypted content from the mobile terminal; and
forwarding the valid authentication key associated with the encrypted content to the communication terminal.

9. The method of claim 8, further comprising transmitting to the second mobile terminal a sample key to access a portion of the encrypted content upon receiving a download request from the second mobile terminal.

10. The method of claim 8, further comprising posting a notice regarding the encrypted content.

11. The method of claim 8, wherein the encrypted content is a User Created Content (UCC) or a User Generated Content (UGC).

12. The method of claim 8, wherein transmitting the request for the valid authentication key to the mobile terminal uses an SMS or MMS message.

13. The method of claim 8, further comprising transmitting a payment to a user of the mobile terminal.

14. A content providing method comprising:
sending, by a communication terminal, a request for a valid authentication key associated with an encrypted content to a content providing server, the encrypted content being encrypted by a mobile terminal;
sending, by the communication terminal, a user fee to the content providing server; and
receiving, by the communication terminal, the valid authentication key associated with an encrypted content from the content providing server.

15. The method of claim 14, further comprising sending, by the communication terminal, a download request for the encrypted content to the content providing server; and
receiving, by the mobile terminal, a sample key associated with the encrypted content, the sample key allowing access to a portion of the encrypted content.

16. The method of claim 14, wherein the encrypted content is a User Created Content (UCC) or a User Generated Content (UGC).

17. A content providing system comprising:
a mobile terminal encrypting and providing a content, the mobile terminal comprising:
an encryption module encrypting a content and generating a valid authentication key and a sample key; and
a content manager registering the encrypted content and the sample key with a content providing server, and transmitting the valid authentication key to the content providing server in response to a request from the content providing server.

18. The system of claim 17, wherein the content is a User Created Content (UCC).

19. The system of claim 17, wherein the sample key is an authentication key permitting decryption of only a part of the encrypted content.

20. The system of claim 17, wherein the request for the valid authentication key to the mobile terminal using an SMS or MMS message.
